(19) United States
(12) Patent Application Publication
(10) Pub. No.: US 2012/0198380 A1
(43) Pub. Date: Aug. 2, 2012

(54) CONTEXTUAL USER INTERFACE

(76) Inventor: Shimshon Czertok, Houston, TX (US)

(21) Appl. No.: 13/384,912

(22) PCT Filed: Mar. 31, 2010
(86) PCT No.: PCT/US2010/029469

§ 371 Date: Jan. 19, 2012

(51) Int. Cl. G06F 3/048; G06F 17/30

(52) U.S. Cl. 715/780; 715/810

(57) ABSTRACT

Embodiments of the present invention disclose a contextual user interface for a computer system including a database and processor. According to one embodiment, a plurality of activities are associated with an application and stored in the database. Furthermore, a set of activities from the plurality of activities are displayed on a user interface. Upon receiving an activity request for a desired activity from a user, the processor determines the application associated with the desired activity and identifies data to be accessed by the application. The contextual user interface is then configured to automatically launch the application along with the identified data.

### BACKGROUND

The ability to provide efficient and intuitive interaction between computer systems and users thereof is essential for delivering an engaging and enjoyable user-experience. A computer user interface is commonly used for facilitating interaction between a user and a computer and generally includes an input means for allowing a user to manipulate the computer system and an output means for allowing the computer system to indicate the effects of the manipulation. Today, most computer systems employ icon-based user interfaces that utilize desktop icons and application menus for assisting a user in navigating content on the computer system. However, the icon-based user interface system is primarily focused and configured to simply open a particular application associated with a selected icon, and does not take into consideration what the user actually wants to do or perform.

### BRIEF DESCRIPTION OF THE DRAWINGS

The features and advantages of the inventions as well as additional features and advantages thereof will be more clearly understood hereinafter as a result of a detailed description of particular embodiments of the invention when taken in conjunction with the following drawings in which:

FIG. 1 is a simplified block diagram of the computer system implementing the contextual user interface according to an embodiment the present invention.

FIG. 2A is a three-dimensional view of a computer system implementing the contextual user interface, while FIG. 2B is an exemplary screenshot of the contextual user interface according to an embodiment of the present invention.

FIG. 3 is a flow diagram of the processing steps of the contextual user interface according to an embodiment of the present invention.

### NOTATION AND NOMENCLATURE

Certain terms are used throughout the following description and claims to refer to particular system components. As one skilled in the art will appreciate, companies may refer to a component by different names. This document does not intend to distinguish between components that differ in name but not function. In the following discussion and in the claims, the terms “including” and “comprising” and “e.g.” are used in an open-ended fashion, and thus should be interpreted, to mean “including, but not limited to . . . ”. The term “couple” or “couples” is intended to mean either an indirect or direct connection. Thus, if a first component couples to a second component, that connection may be through a direct electrical connection, or through an indirect electrical connection via other components and connections, such as an optical electrical connection or wireless electrical connection. Furthermore, the term “system” refers to a collection of two or more hardware and/or software components, and may be used to refer to an electronic device or devices, or a sub-system thereof.

### DETAILED DESCRIPTION OF THE INVENTION

The following discussion is directed to various embodiments. Although one or more of these embodiments may be preferred, the embodiments disclosed should not be interpreted, or otherwise used, as limiting the scope of the disclosure, including the claims. In addition, one skilled in the art will understand that the following description has broad application, and the discussion of any embodiment is meant only to be exemplary of that embodiment, and not intended to intimate that the scope of the disclosure, including the claims, is limited to that embodiment.

Icon-based, user interface systems require a substantial amount of application and file management knowledge from the user. For example, when a user desires to play a movie or song downloaded from the internet, the user needs to 1) determine which media player to use, 2) launch the specific player, and 3) determine how to open and play the particular file associated with the movie or song. Furthermore, such systems do not provide adequate troubleshooting options for the non-sophisticated user that lacks intricate knowledge of every application on their computer system. For example, if a user wants to play or open a particular file but doesn't know which specific application is required or necessary for playback or viewing, conventional interface systems may allow the user to perform a system search for the precise application. More often than not, however, the search results are unhelpful, misleading, or incorrect. As a result, the user will either abandon their effort or possibly download an additional application from the web, which only serves to complicate and frustrate matters even further.

Embodiments of the present invention disclose a system and method for a contextual user interface. According to one embodiment, the contextual user interface provides a simplified interface that allows users to instantly perform an activity or function such as “watch Lion King”, “listen to music”, or “go to cnn.com”. That is, the contextual user interface of the present embodiments is configured to execute a desired user activity, or an event on the computer system involving the launching of a specific application and retrieval of a specific file or object (i.e. data) associated therewith.

Embodiments of the present invention focus on activities that a user executes on their computers or devices by essentially answering the question “what do you (user) want to do?” For example, watching a movie on a movie player application such as Quicklime™ by Apple Computer Inc. or Windows Media Player™ by Microsoft Corporation, or searching the web via a web browser application such as Internet Explorer™ or Mozilla Firefox™ would be an activity. The database of the computer system is searched and the appropriate application and data is immediately determined and automatically launched. As such, embodiments of the present invention enables users to immediately execute a desired activity rather than force the user to learn and use a complex application or set of applications associated with a single file or object.

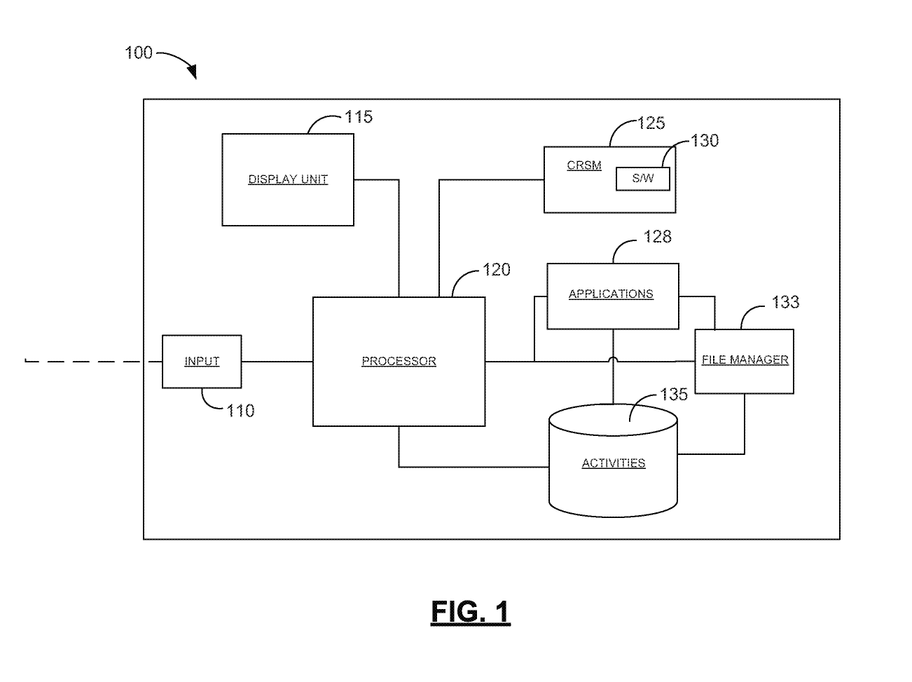

Referring now in more detail to the drawings in which like numerals identify corresponding parts throughout the views, FIG. 1 is a simplified block diagram of a computer system implementing the contextual user interface according to an embodiment of the present invention. As shown in this exemplary embodiment, the system 100 includes a processor 120 coupled to a display unit 115, an activity database 135, software applications 128, a file manager 133, and a computer-readable storage medium 125, In one embodiment, processor 120 represents a central processing unit configured to execute program instructions. Display unit 130 represents an electronic visual display or touch-sensitive display such as a desktop flat panel monitor configured to display images and a graphical user interface for enabling interaction between the user and the computer system. Storage medium 125 represents volatile storage (e.g. random access memory), non-volatile store (e.g. hard disk drive, read-only memory, compact disc read only memory, flash storage, etc.), or combinations thereof. Furthermore, storage medium 125 includes software 128 that is executable by processor 120 and, that when executed, causes the processor 120 to perform some or all of the functionality described herein.

File manager 133 may represent a computer program configured to manage the manipulation of documents and data files in the compute r system 100. Applications 128 represent various types of computer software that assist users in performing a specific task. For example, applications 128 may include a web browser utilized for browsing the internet, a word processor for creating and opening text documents, or a media player for enabling movie and music playback. Furthermore, activity database 135 represents a structured, data collection of activities, applications, and files or objects. According to one embodiment, activity database 135 utilizes a relational model for management of the activity data.

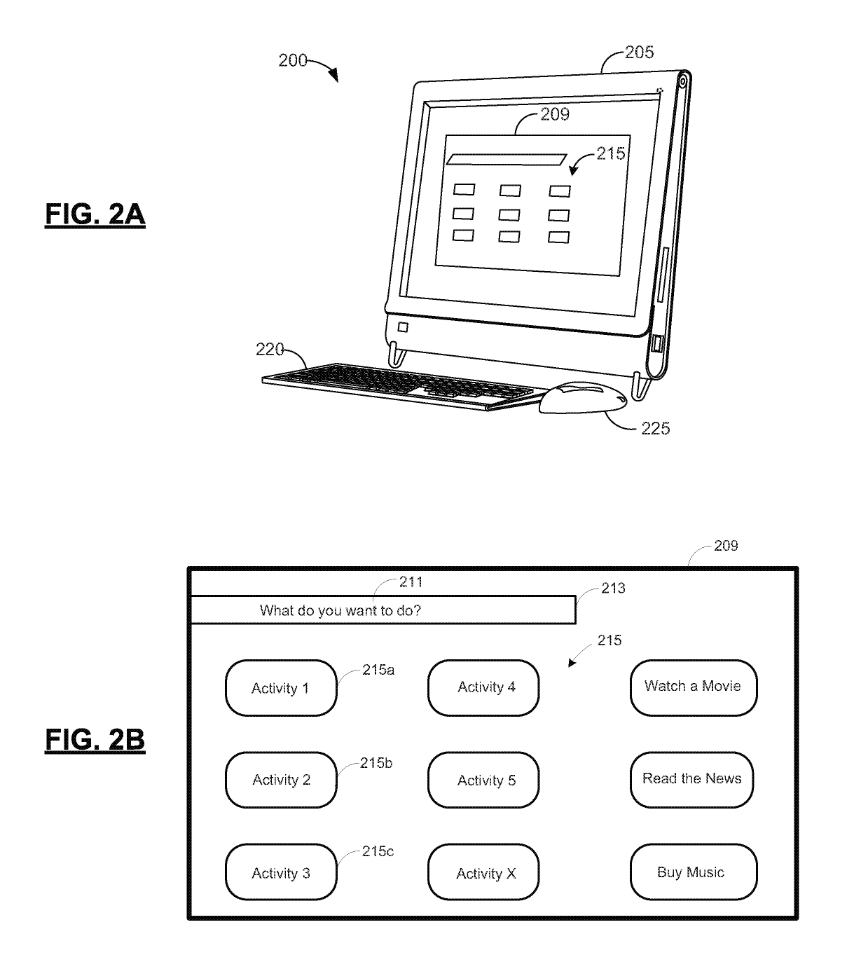

FIG. 2A is a three-dimensional view of a computer system implementing the contextual user interface, while FIG. 2B is an exemplary screenshot of the contextual user interface according to an embodiment of the present invention. As shown in FIG. 2A, system 200 is an all-in-one computer including a mouse 225 and keyboard 220 for user input, and a display unit 205 for displaying the contextual user interface 209. Turning now to FIG. 2B, the contextual user interface 209 may include a text entry bar 213 and a list of interface activity selectors 215 including individual activity selectors 215a-215c. According to one embodiment, the contextual user interface 209 is completely optimized for touch-enabled functionality, but the interface 209 also supports mouse 225, keyboard. 220, and other similar input means.

In the embodiment of FIG. 2B, interface activity selectors 215a-215c represent buttons that are selectable, via a mouse click or touch selection on a touchscreen-enabled display unit. Upon selection or activation of one of the activity selectors or buttons 215a-215c, an activity linked to that particular selector will be immediately launched. For example, if the user submits an activity request by selecting (via mouse click or touch) a particular activity selector associated with an activity such as “Watch a Movie”, a movie player application (e.g. QuickTime) will launch and the user interface 209 may prompt the user for the location of the desired movie file (i.e. assuming multiple files). According to one embodiment, the contextual user interface may be pre-populated with a predefined list of activity interface selectors 215, or as an initial blank list for personal customization by a user.

The text entry box 213 is utilized by the user to manually type or input an activity request, and also to perform a text search for a particular application, file, or object. The user interface system 200 is configured, to recognize text entry of the name of a file or object in the text box 213. and automatically determine and launch the appropriate application. For example, if the user types “Avatar”, the contextual user interface will recognize that the user has a file called “Avatar” in his video file folder and therefore launch this data file in an appropriate media player. Still further, the user interface of the present embodiments is configured to ensure that one application is utilized over another appropriate application. For example, a Windows Media Player will launch for playback of the “Avatar” movie data file instead of a QuickTime media player if both players are installed on the computer system and the Windows Media Player has a higher rank value, which may be established based on prior user activity or assignment, or as a default value set by the system as will be explained in further detail below.

Specifically, the contextual user interface of the present embodiments may learn the preferred activities of a user and may move the associated activity selectors to the top of the list of activity selectors 215. In one embodiment, each activity is initially assigned a rank value in which activities with a higher rank value have higher priority than those activities with a lower rank value. That is, interface activity selector 215a (“Activity 1”) has a higher rank value than interface activity selector 215b (“Activity 2”) and interface activity selector 215c (“Activity 3”). For example, if the system 200 consistently processes “Watch a Movie” activity requests, either via text entry by the user or manual selection of a “Watch a Movie” activity selector on the user interface 209, the processor may assign this activity as a preferred activity by automatically increasing the rank value of the “Watch a Movie” activity selector, enabling this particular activity to surpass other activities on the selector list 215 having a lower value than the assigned rank value of the assigned preferred activity. Accordingly, the system 200 may “learn” the user's preferences and automatically move that particular activity selector to the top of the activity selector list 215 for the user's convenience.

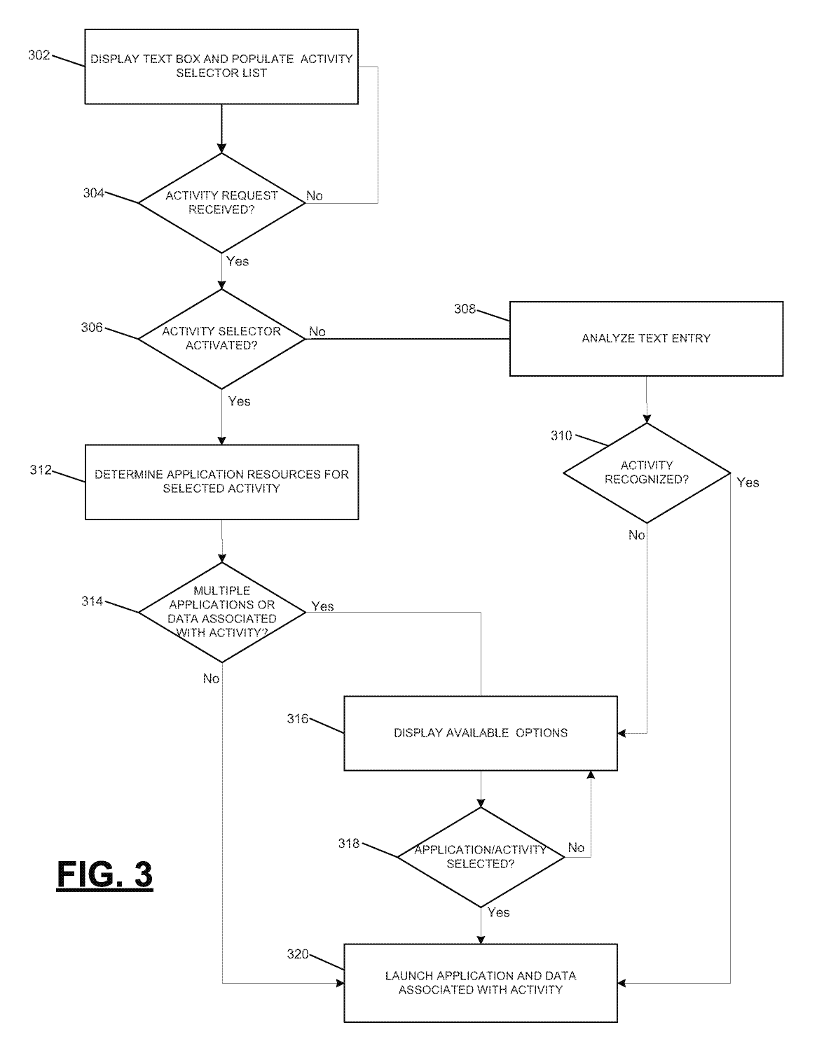

FIG. 3 is a flow diagram of the processing steps of the contextual user interface according to an embodiment of the present invention. In step 302, the contextual user interface is displayed with the text entry box and the interface activity selector is populated in ranked order as detailed above. Then, in step 304, the processor determines if an activity request was received, either via activation of an interface activity button by the user or via user input of a string of alphanumeric characters within the text box. If it is determined that an activity selector was selected in step 306, then the processor searches the database and determines the application and resources for the selected activity in step 312. Furthermore, if a single application is associated with the selected activity, then the processor automatically launches the application in step 320 and may prompt the user for the selection of additional data such as the name of a particular file or object if needed (alternatively, the prompt may occur prior to launching the application). For example, selection of “Watch a Movie” activity selector will launch a media player and prompt the user for a desired movie name (i.e. data file), or selection of a “browse the web” activity selector will launch a web browser application and prompt the user for uniform resource locator data (i.e. object data).

If on the other hand, an interface activity selector was not selected in step 306 and an activity request was received in the text box, then in step 308, the processor analyzes each character in the string of alphanumeric characters input by the user. In one embodiment, the processor analyzes the text entry by comparing the character string, and portions thereof, with a known activity, stored data files, keywords, or object data associated with an activity. If the activity is immediately recognized in step 310, then at least a portion of the string of alphanumeric characters is immediately identified as a known activity or keyword, and the associated application will automatically launch and be presented to the user for operation. For example, if the user inputs the alphanumeric character string “cnn.com” in the text box, the contextual user interface system may analyze the character string and recognize the “.com” portion of the string as a keyword that is associated with a uniform resource locator (URL) for a web browser application. Accordingly, the system opens a web browser application with “www.cnn.com” as the URL in the address bar.

If on the other hand, the entered character string is not immediately identified in step 310, or if there are multiple applications or files associated with the desired activity in step 314, then the user interface may offer the available options for selection by the user in step 316. For example, if the user types a character string “video” in the text box, then the user interface will need to determine if the user wants to watch, shoot, or edit a video by displaying a list of available activity options (i.e. shoot, edit, watch) in step 316. Similarly, if there are multiple installed media players (e.g. QuickTime, Windows Media Player for movie playback, then the contextual user interface will display the available application options in step 316. Upon user selection of the activity or application in step 318, then the application and data (e.g. file, object) associated with the selected activity is automatically and immediately launched for operation by the user.

Furthermore, if the activity was previously unidentified or undefined, then after launching the application and data, the processor may register the text entry or keyword as a new activity in the database for future system reference. Accordingly, the contextual user interface system of the present embodiments is capable of learning new activities based, on user interaction with the system. Furthermore, the keywords may be fed to online repository and shared with an online user community so that other users may update their own contextual user interface with the same keywords and the associated activities.

Embodiments of the present invention provide a system and. method for a contextual user interface. Many advantages are afforded, by the contextual user interface in accordance with embodiments of the present invention. For instance, the contextual user interface significantly simplifies the computing experience for the user as there will be no need for the user to learn the intricacies and particularities of each application on their computer system. Instead, a user need only to submit an activity request and the system automatically launches an associated application along with the desired data file or object data. As such, interaction between the user and the computer system is much more intuitive and efficient than conventional icon-based interface systems.

Furthermore, while the invention has been described with respect to exemplary embodiments, one skilled in the art will recognize that numerous modifications are possible. For example, although exemplary embodiments depict an all-in-one computer as the system incorporating the contextual user interface, the invention is not limited thereto. For example, the contextual interface may be implemented on a notebook, netbook, a tablet personal computer, an electronic reading device, a cell phone device, or any other electronic device having a display unit and processor. Thus, although the invention has been described with respect to exemplary embodiments, it will be appreciated, that the invention is intended to cover all modifications and equivalents within the scope of the following claims.

What is claimed is:

1. A method, for interacting with a computer system comprising a database and processor, the method comprising:
storing a plurality of activities in the database;
associating, via the processor, each of the plurality of activities with at least one application;
displaying at least one activity from the plurality of activities on a user interface associated with the computer system;
receiving, via the user interface, an activity request for a desired activity from a user;
determining, via the processor, the at least one application associated with the desired activity:
identifying data to be accessed by the determined application; and
automatically launching, via the processor, the application associated, with the desired activity along with the identified data.

2. The method of claim 1, further comprising:
assigning, via the processor, a rank value for each activity in the plurality of activities;
determining, via the processor, at least one preferred activity from the plurality of activities; and
wherein the preferred activity is assigned a higher rank value than the activities not determined, as preferred activities.

3. The method of claim 2, further comprising:
displaying, on the user interface, a plurality of interface activity selectors capable of selection by a user, wherein each interface activity selector is associated with an activity in the plurality of activities, and
wherein the plurality of interface activity selectors are displayed in order of rank value from highest to lowest such that a higher ranked activity is displayed, before a lower ranked activity.

4. The method, of claim 3, further comprising:
displaying, on the user interface, a text box for user input of a string of alphanumeric characters related to a desired activity.

5. The method of claim 4, wherein the activity request includes either input of a string of alphanumeric characters within the text box or selection of an activity selector.

6. The method of claim 5, wherein the rank value of the activity is determined based on the number of times a user submits an activity request for the activity.

7. The method, of claim 5, where if the activity request comprises user input of a string of alphanumeric characters, the method further comprises:
analyzing each character in the string of alphanumeric characters; and
determining a desired application based on at least a portion of the string of characters.

8. The method of claim 5, wherein if the activity request comprises user selection of an interface activity selector, the method further comprises:
determining, via the processor, the activity associated with the selected interface activity selector;
submitting a data request to the user for data to be accessed by said, application.

9. A system comprising:
a display coupled to a processor;
a database coupled, to the processor and configured to store a plurality of activities, wherein each activity is associated with an application; and
a user interface configured to receive input from a user for activating a desired activity;
wherein upon receiving input from a user, the processor is configured to:
determine the at least one application associated, with the desired, activity;
identify data to be accessed by the determined application, and
automatically launch the application associated with the desired activity.

10. The system of claim 9, wherein the user interface includes a text box for text entry of a desired activity and at least one interface activity selector for user selection of a desired activity.

11. The system of claim 10, wherein a rank value is assigned to each interface activity selector based on the number of times a user has selected the activity; and
wherein a plurality of interface activity selectors are displayed on the user interface in order of rank value.

12. A computer readable storage medium having stored executable instructions, that when executed by a processor, causes the processor to:
store a plurality of activities in a database of a computing system;
associate each of the plurality of activities with at least one application; and
display a set of activities from the plurality of activities on a user interface associated with the computing system,
wherein upon receiving an activity request for activation of a desired activity from the user via the user interface, the executable instructions cause the processor to:
determine the at least one application associated, with the desired, activity along with data to be accessed by the determined application; and
automatically launch the application and data associated with the desired activity.

13. The computer readable storage medium of claim 12, wherein if more than one application is determined to be associated, with the desired, activity, then the executable instructions further cause the processor to:
identify a plurality of possible activities associated with the determined applications, and
display each possible activity associated with the desired activity on the user interface.

14. The computer readable storage medium of claim 12, wherein the executable instructions farther cause the processor to:
assign a rank value for each activity in the plurality of activities;
determine at least one preferred, activity from the plurality of activities; and
wherein the preferred activity is assigned a higher rank value than the activities not determined as preferred activities.

15. The computer readable storage medium of claim 14, wherein the executable instructions further cause the processor to:
display the plurality of activities on the user interface in order of rank value from highest to lowest such that a higher ranked activity is displayed before a lower ranked activity.
